(19) United States
(12) Patent Application Publication
(10) Pub. No.: US 2005/0120855 A1
(43) Pub. Date: Jun. 9, 2005

(54) Gel cutter for recovering DNA, RNA and protein from agarose gel and poly-acrylamide gel

(76) Inventor: Youmin Shu, Potomac, MD (US)

Correspondence Address: Youmin Shu, 2508 Chilham Plaec, Potomac, MD, 20854, US

(21) Appl. No.: 10/729,061

(22) Filed: Dec. 6, 2003

(51) Int. Cl. B26F 1/14

(52) U.S. Cl. 83/684; 83/123

(57) ABSTRACT

The present invention relates to all facets of a novel cutting tool designed to retrieving gel slice from an agarose gel and poly-acrylamide gel. The cutting tool is made of plastics or metal materials and consists of a tool body and a plug. The upper end of the rectangle tube is open. A plug is inserted into the rectangle tube from the upper end of the tube to form the cutting tool. The rectangle shape and the plug of the cutting tool make gel-cutting and gel-ejecting much easier and more precise.

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND OF THE INVENTION

1. Field of Invention

The present invention relates to a cutting tool used in life science filed. More specifically, the present invention relates to a cutting tool for cutting and retrieving gel slice containing biopolymers (DNA, RNA and Protein) from Agarose gel and Poly-Acrylamide gel after electrophoresis.

2. Background of the Invention

In life science field, the methods of gel electrophoreses are used to separate biopolymers such as DNA, RNA and protein molecules based on their molecular weights and physical characteristics. After the separation, the biopolymers are stained and visualized. In particularly, Agarose gel electrophoresis is used to separate DNA molecules based on the their sizes. After the separation, an Agarose gel is stained with Ethidium Bromide which binds to the DNA molecules. The labeled DNA bands can be visualized under UV lights. In many cases, separated DNA bands are required to be isolated from the Agarose gel for DNA purification. This process requires a user to retrieve the gel slice containing desired DNA bands. A common method to retrieve the gel slice is using a razor blade or a scalpel to cut the desired gel slice out under the UV lights. Using a razor blade or a scalpel has a number of disadvantages:
(a) It is difficult to cut a desired gel area precisely. Therefore, it sometimes causes losing DNA sample and retrieving undesired gel area.
(b) A razor blade or scalpel is so sharp that it sometimes hurts users. Since the cutting tool is contaminated with Ethidium Bromide, a potent carcinogen, this toxic chemical may be brought in to the user's body. Such an accident is extremely harmful to the user.
(c) A razor blade and scalpel is made of metal, thus it can be become rusted. It is bio material and requires special procedure to dispose them.
(d) A sharp blade often leaves permanent marks on the quartz glass of UV box, which affects quality of subsequent gel pictures.

### SUMMARY

The present invention relates to cutting tools for cutting and retrieving gel splice from Agarose gel and Poly-Acrylamide gel. The cutting tools are made of plastics or metal materials. The cutting tool consists of a tool body and a plug. One end of tool body is a rectangle or rounded rectangle tube for cutting, and the other end is round bar for handling. The tool body has a thin edge at the end of the tube designed to cut through a gel easily. The upper end of the rectangle tube is open. A plug is inserted into the rectangle tube from the upper end of the tube to form the cutting tool. The plug is designed to push the gel slice out of the tube. When cutting through the gel, the gel slice is pushed into the tube and can be carried to a desired location. To eject out the gel slice, one can push down the plug. Consequently, the gel slice is moved out of the tube and transferred to a new container, such as a test tube.

The size of DNA bands are depended on the width of comb teeth used to make an Agarose gel, which can be in different sizes due to different manufactures. To accommodate the various widths of DNA bands, the cutting tool is designed in a serial of sizes. The width of the rectangle of the present tools ranges from 2 to 10 mm, and the length of the rectangle ranges from 3 to 40 mm.

The present invention has a number of advantages:
(a) Cut bands precisely and fast to minimize the exposure of user's body and DNA sample to UV-lights because the cutting tool can precisely cover the band, and only one push is needed to take the band. If cutting with a razor blade, at least four times of cutting are needed to retrieve a band.
(b) Handle and eject the band conveniently. The gel slice stays inside the rectangle tube and can be carried from place to place. The plug facilitates to push out the gel slice to a new container for downstream process.
(c) Avoid damaging the glass of UV-light box and cutting user's body because the thin edge is not shape enough to cause such damages.
(d) Easy to be disposed. When made of plastics, the cutting tools can be easily disposed after proper treatment, thus it is much more friendly to the environment.

### DRAWINGS—FIGURES

FIG. 1a shows the front view of the cutting tool. The tool body is indicated by “1”. The plug of the tool is indicated by “2”.

FIG. 1b shows the half cross-sectional side view of the cutting tool. The tool body is indicated by “1”. The plug of the tool is indicated by “2”.

FIG. 1c shows the rear view of the cutting tool.

FIG. 1d shows the bottom view of the cutting tool.

FIG. 2a shows the front view of the plug of the cutting tool.

FIG. 2b shows the half cross-sectional side view of the plug of the cutting tool.

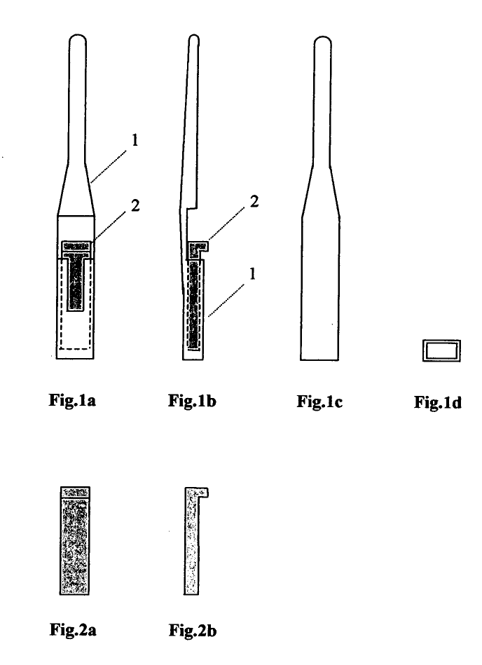

1. A cutting tool for cutting and retrieving gel slice from an Agarose gel and Acrylamide gel comprising:
a) A rectangle shaped tube at one end and a round shaped handle at the other end.
b) A removable plug is inserted from the upper end into the rectangle tube.

2. A cutting tool as recited in claim 1, where in said rectangle tube is fabricated from plastics or metal materials.

3. A cutting tool as recited in claim 1, where in said plug is fabricated from plastics or metal materials.

4. A cutting tool as recited in claim 2, where in said width of rectangle is between 2 and 10 mm and said length of rectangle between 3 and 40 mm.
